(19) United States
(12) Patent Application Publication
(10) Pub. No.: US 2006/0186198 A1
(43) Pub. Date: Aug. 24, 2006

(54) Discrimination apparatus and roller assembly

(76) Inventors: Masanori Terao, Owarikomaki (JP); Shinji Shibata, Nagoya (JP); Shinya Miwa, Owarikomaki (JP)

Correspondence Address: MCDERMOTT WILL & EMERY LLP, 600 13TH STREET, N.W., WASHINGTON, DC, 20005-3096, US

(21) Appl. No.: 11/249,145

(22) Filed: Oct. 13, 2005

(30) Foreign Application Priority Data
Feb. 18, 2005 (JP) 2005-041532

(51) Int. Cl. G06F 7/08

(52) U.S. Cl. 235/381

(57) ABSTRACT

A fixed driving roller shaft not actuated vertically is disposed facing a sheet-reading sensor. Low-hardness sensor-opposed rollers each having a fixed clearance with respect to the sheet-reading sensor are arranged at positions opposed thereto. Transport rollers harder than the sensor-opposed rollers are arranged at positions not opposed to the sheet-reading sensor. The opposed sections of the transport rollers are formed into the sheet-transporting and sensor-opposed roller construction that has tension rollers arranged at the positions where the tension rollers come into contact with the associated transport rollers.

### BACKGROUND OF THE INVENTION

The present invention relates to a discrimination apparatus constructed inside the automatic teller machine that handles paper currencies, and more particularly, to a roller assembly arranged for the paper-like sheet reader (for example, magnetic sensor) that constitutes the discrimination apparatus.

### DESCRIPTION OF RELATED ART

In current automatic teller machines (ATMs) or cash dispensers, securities handling machines, and the like, a sheet-reading sensor that reads the information printed on sheets of paper to discriminate the kind and genuineness/falseness of sheet is disposed on respective paper-like sheet transport paths. Related techniques are disclosed in Japanese Patent Laid-open Nos. 02-50289 and 2000-113268.

### BRIEF SUMMARY OF THE INVENTION

A description will be below made of problems associated with the magnetic reading sensors and others detecting and/or reading the magnetic information printed on paper-like sheets.

Firstly, when contact rollers are arranged at positions opposed to a sheet-reading sensor, since the surface of the sensor and the outer surfaces of the rollers are in contact with each other, driving these rollers poses the problem in that wear due to mutual contact occurs on the detection surface of the sensor that is a fixed surface, and on the outer surfaces of the rollers which are rotary bodies. Demanding any driving force from these rollers, therefore, is not preferable. For example, these contact rollers may be arranged as racing rollers designed so that when a sheet of paper is not being transported, the rollers are in a stopped state, and so that when a sheet of paper is transported, the rollers are driven to rotate according to the particular transport distance of the sheet. Even in such arrangement of the rollers, however, sufficient transport force cannot be given to the sheet.

Secondly, when non-contact rollers are arranged at positions opposed to a sheet-reading sensor and with a clearance equivalent to the thickness of about one sheet of paper, although a certain degree of driving can be given, there is a need to allow for simultaneous transport of plural media or transport of media of unusual shapes or quality. One possible measure for transporting these kinds of media would be to adopt either a mechanism that slides the rollers vertically with respect to the transport direction of paper, or a mechanism that deforms the outside-diametral portions of the rollers. In these cases, however, it becomes necessary to transport the sheet of paper while holding it between the driving rollers that give a fixed transport speed to the sheet, and the sensor surface that suffers frictional resistance since the sensor itself does not follow the transport distance of the sheet. The resulting difference in frictional resistance between the surface and reverse of the sheet transported will cause the instability of transport performance.

Therefore, it does not become an effective solution to arrange the transport rollers that give stable transport force to the sheet, at positions opposed to the sensor. Alternatively, in order to stabilize and improve sheet transport performance, transport rollers may be arranged in proximity to a sheet-reading sensor, in front and rear of the sensor, or the sheet-reading sensor may have the shape matching the spacing between the transport roller shafts used. These methods, however, present problems such as increases in the dimensions of the apparatus, an increase in price, or sensor size restrictions.

In order to solve part of the above-described problems, a fixed driving shaft not operating vertically is disposed at a position opposed to a sheet-reading sensor disposed on one side of the sheet transport path in a sheets-of-paper reader, and a plurality of resilient rollers each different in hardness from each other are arranged coaxially with respect to the driving shafts. In addition, at positions opposed to the sheet-reading sensor, one or more resilient rollers of low hardness are arranged to stabilize the distance between the sensor and the sheet of paper transported, and to ensure a fixed clearance with respect to the sensor. One or more transport rollers or resilient rollers having hardness greater than the resilient rollers of low hardness are arranged at positions not oppose to the sheet-reading sensor. At portions opposed to the above transport rollers, tension rollers supported so as to be rotatable to follow the thickness and transport distance of the sheet are arranged at the positions where the tension rollers come into contact with the transport rollers.

### BRIEF DESCRIPTION OF THE DRAWINGS

FIG. 1 is a side view of a sheets-of-paper reader according to an embodiment of the present invention;

FIG. 2 is a detailed front view of sheet-transporting and sensor-opposed rollers in the embodiment of the present invention;

FIG. 3 is a perspective view showing the relationship in position between sheet-transporting and sensor-opposed rollers and sheet-reading sensors according to the embodiment of the present invention; and

FIGS. 4A and 4B show another perspective views showing the relationship in position between sheet-transporting and sensor-opposed rollers and sheet-reading sensors according to the embodiment of the present invention.

### DETAILED DESCRIPTION OF THE INVENTION

Preferred embodiments of the present invention will be described in detail below with reference to the accompanying drawings. The present invention, however, is not limited by the description.

Automatic teller machines (ATMs) process deposits, payments, and other transactions on paper currencies automatically, and discriminate these paper currencies during the transactions. Paper currencies are discriminated by one discrimination unit (also referred to as a discriminator), and this discrimination unit mainly judges denominations and genuineness/falseness of the paper currencies. Major constituent elements of the discrimination unit include a photosensor that irradiates each paper currency with light of a certain wavelength and detects the light reflected from or passed through the currency, and a magnetic sensor that detects the magnetism contained in the currency (this sensor is also referred to a magnetic reading sensor). Embodiments of the present invention, based mainly on arrangement, configuration, and other factors of rollers neighboring such a magnetic sensor, will be described below with reference to the accompanying drawings.

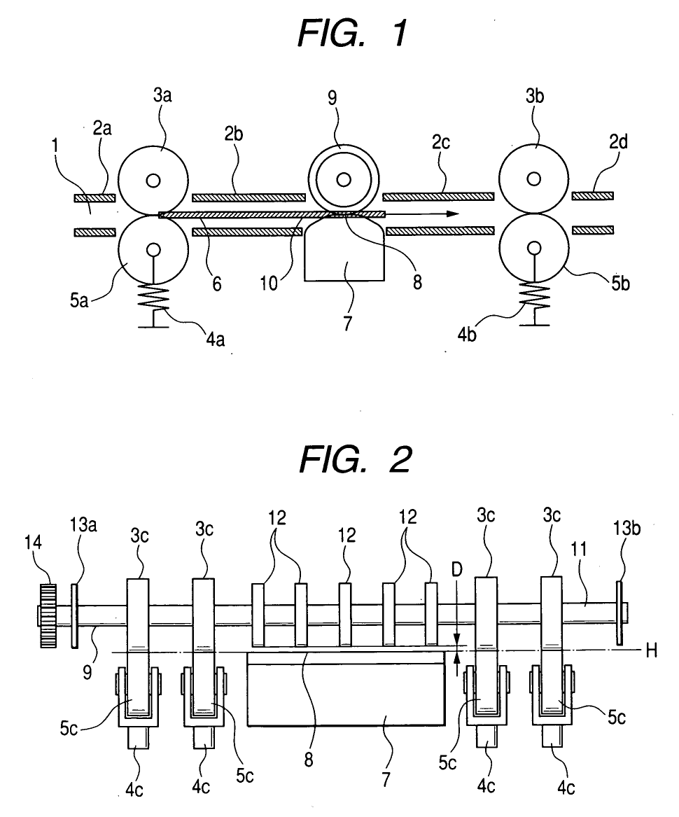

FIG. 1 is a partial side view of a discrimination unit in an embodiment, showing mainly a magnetic reading sensor (hereinafter, also referred to as sheet reader or sheet-reading sensor) that allows for improvement and stabilization of reading performance and transport performance for the magnetic information printed on paper currencies. No description is given of discrimination unit components or sections not concerned with the present invention, such as a substrate, an enclosure, and a photosensor.

Transport guides 2a, 2b, 2c, 2d are arranged at required spatial intervals above and under a transport path 1 formed to transport a sheet of paper (paper currency) 6. In addition to the transport guides 2a-2d, a transport roller 3a is placed on the upstream side of the transport path 1, a transport roller 3b is placed on the downstream side thereof, and tension rollers 5a, 5b are arranged at positions opposed to the transport rollers 3a, 3b, respectively. The tension rollers 5a, 5b are supported by respective retaining springs 4a, 4b so as to come into contact with the transport rollers 3a, 3b, respectively. Also, the tension rollers 5a, 5b are adapted to rotate as the transport rollers 3a, 3b rotate by driving. While being held between the transport rollers 3a, 3b and the tension rollers 5a, 5b, the sheet of paper 6 (hereinafter, referred to simply as the sheet 6) is transported in a direction of an arrow, along the transport guides 2a-2d. A sheet-reading sensor 7 which reads features of the paper currency is disposed on the transport path 1, having a detection surface 8 parallel to a transport direction of the sheet. At a position opposed to the sheet-reading sensor 7, a sheet-transporting and sensor-opposed roller (also referred to simply as resilient roller) 9 is disposed as a driving roller of a fixed shaft, with a fixed clearance (spatial interval) with respect to the sheet-reading sensor 7. The sheet-reading sensor 7 reads magnetic information 10 of the sheet 6 transported. The sheet can be transported bi-directional from an upstream direction to a downstream direction (the direction of the arrow in FIG. 1), and vice versa. The sensor 7, therefore, can also detect the magnetic information of the sheet during bi-directional transport thereof. Since the transport rollers 3a, 3b are arranged with a spacing greater than a width of the sheet, the sheet-transporting and sensor-opposed roller 9 has the sheet transport force described later in this document.

Next, a detailed shape of the sheet-transporting and sensor-opposed roller 9 and a positional relationship thereof with respect to the sheet-reading sensor 7 will be mainly described using FIG. 2. FIG. 2 is a front view of the discrimination unit of FIG. 1 as viewed from an upstream or downstream direction.

Among features of the sheet-transporting and sensor-opposed roller 9 is that two kinds of rubber rollers different in hardness from each other are arranged in plural places in an axial direction of one shaft 11.

The rollers arranged at positions where they are opposed to the sheet-reading sensor 7 are described first. As shown, a plurality of (in FIG. 2, five) sensor-opposed rollers 12 are installed on and fastened to the shaft 11, and the rollers 12 use rubber roller materials of low hardness. The low-hardness rubber here refers to the rubber falling within a range from 15 to 30 HS in terms of rubber hardness when the hardness is measured using a method specified in “JIS K 6253”, and silicon rubber with a rubber hardness of 15 HS, in particular, is used in the present embodiment. Such rubber hardness of the sensor-opposed rollers 12 is determined that prevents sheet transport operations, including simultaneous transport of plural sheets and transport of sheets of unusual shapes or quality, from causing load torque greater than motor torque when the sheets move past outside diametral sections of the resilient rollers while deforming these outside diametral sections.

Rollers not opposed to the sensor 7, namely, transport rollers 3c are described next. The transport rollers 3c, as shown, are installed on and fastened to the shaft 11, and arranged in such a form as to sandwich the sensor-opposed rollers 12 from both sides. The transport rollers 3c use a rubber material harder than that of the sensor-opposed rollers 12. That is to say, a rubber material whose hardness ranges from 70 to 90 HS is used for the transport rollers 3c. More specifically, urethane rubber of 90H is used in the present embodiment. The use of this harder rubber material makes it possible to minimize wear due to friction during the transport of sheets and to stably transport the sheets. Four transport rollers 3c, two on each side of the sensor-opposed rollers 12, are arranged, and a tension roller 5c is disposed at each transport roller 3c and supported by a retaining spring 4c so as to come into contact with the transport roller 3c. A driving motor not shown rotates the shaft 11, and the driving force given thereto rotates the transport roller 3c. The rotation of the transport roller 3c also causes the tension roller 5c to rotate.

As described above, the fact that the sheet-transporting and sensor-opposed roller 9 that uses rubber materials different in hardness from each other is one feature of the roller 9. The roller 9 also has the feature in which it differs in roller diameter.

As set forth above, there is a need to allow for stable transport of media while at the same time enhancing the sheet-reading sensor 7 in sheet-reading performance. Not only paper currencies would be transported, one at a time, to the discrimination unit, namely, the sheet-reading sensor 7, but also a plurality of currencies might be transported at the same time. In addition, bent or folded paper currencies, the sheets of paper that are not paper currencies, or the media of unusual shapes or quality that are not sheets of paper might be transported. The roller diameters, relative positions of rollers, and roller widths that are suitable for transporting these kinds of media will be described below.

Fixed distance D is ensured as a clearance between the outside diametral section of each sensor-opposed roller 12 forming part of the sheet-transporting and sensor-opposed roller 9, and the sheet-reading sensor 7. This distance is ensured since both ends of the sheet-transporting and sensor-opposed roller 9 are supported by adjustment plates 13a, 13b. Also, driving force from outside is received at a driving gear 14 disposed on the shaft of the sheet-transporting and sensor-opposed roller 9, and the driving force drives the sheet-transporting and sensor-opposed roller 9. In the present embodiment, distance D is set to be equal to 0.25 mm, which is about twice an average thickness of the sheets handled. Stable transport performance can thus be achieved, even during simultaneous transport of plural sheets or transport of media of unusual shapes or quality.

Also, transport height of sheets in a direction vertical to a transport surface directed to a transport direction (in FIG. 2, back and forth direction) of the sheets is shown as H, and a diameter of the transport rollers 3c is set so that sheet transport height H agrees with a height of central portions of the upper and lower transport guides 2a-2d shown in FIG. 1. The example shown in FIG. 2 assumes that the transport rollers 3c have a diameter of 19.6 mm. When the magnetic information printed on each sheet is read using the sensor 7, bringing the sheet into more firm contact with a surface of the sensor 7 makes more accurate detection possible. In order for a sheet 6 to move past a sheet detection surface 8 of the sheet-reading sensor 7 while maintaining contact with the detection surface 8 in this way, the detection surface 8 is disposed so as to have the same height as sheet transport height H. In other words, contact positions of the transport rollers 3c and of the tension rollers 5c are set to be flush with the detection surface 8 of the sensor 7. Since the above-mentioned distance D also needs to be ensured at the same time, the sensor-opposed rollers 12 are arranged coaxially with the transport rollers 3c. For this reason, a diameter of the sensor-opposed rollers 12 is set to be smaller than that of the transport rollers 3c. More specifically, the sensor-opposed roller diameter is 19.1 mm.

As described in the above outline of features, the hardness of the sensor-opposed rollers 12 is lower than that of the transport rollers 3c. In addition, an axial width of the sensor-opposed rollers 12 is desirably smaller than that of the transport rollers 3c. These characteristics make the outside diametral sections of the sensor-opposed rollers 12 easier to deform during simultaneous transport of plural media or during the transport of media of unusual shapes or quality, thus allowing these media to move past the outside diametral sections more easily.

With the above taken into account, the present embodiment assumes that the transport rollers 3c are 19.6 mm in diameter, 5.0 mm in width, and 90° (HS) in hardness, and that the sensor-opposed rollers 12 are 19.1 mm in diameter, 2.5 mm in width, and 15° (HS) in hardness.

Functions of the sensor-opposed rollers 12 are described in further detail below. The sensor-opposed rollers 12, basically, do not need strong force to transport the sheet, since transport force can be obtained by holding the sheet between the transport rollers 3c and the tension rollers 5c. However, even when one genuine paper currency is transported to the sensor 7, the paper currency will be difficult to read with high accuracy, since the currency will warp in an upward direction of the sensor surface 8 in FIG. 2 and move away from the sensor surface 8. The sensor-opposed rollers 12 have a paper-currency transport stabilizing function that suppresses changes in a transport height of the paper-currency transport surface. In addition, the sensor-opposed rollers 12 have hardness lower than that of the transport rollers 3c, are narrower than the transport rollers 3c, and maintain a required distance D with respect to the sensor surface 8 of the sensor 7. These characteristics allow for unusual forms of transport as well, such as simultaneous transport of plural paper currencies and transport of media other than paper currencies. A plurality of non-roller-shaped members made from the same material may be provided as an alternative to arranging the sensor-opposed rollers 12, at the positions where the rollers 12 are to be originally arranged. However, the roller-shaped elements arranged coaxially with the transport rollers 3c, as in the present embodiment, are preferable since the sheets are likely to get caught at the members themselves and result in congestion.

Next, a description will be given below with attention focused on the spacing between the axially arranged rollers, and on the arrangement.

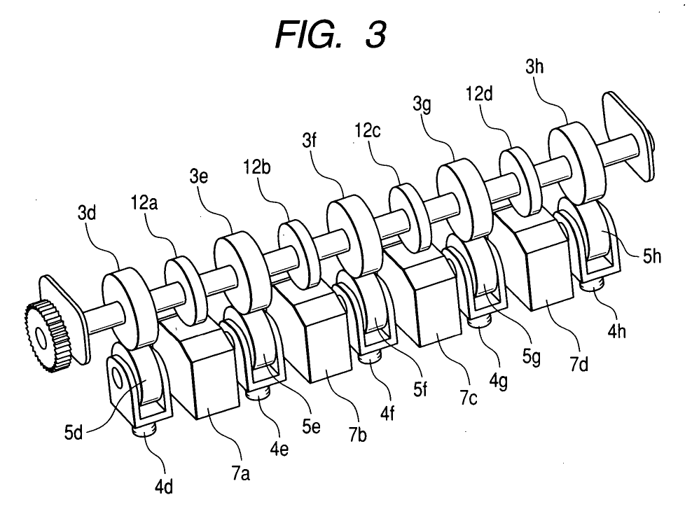

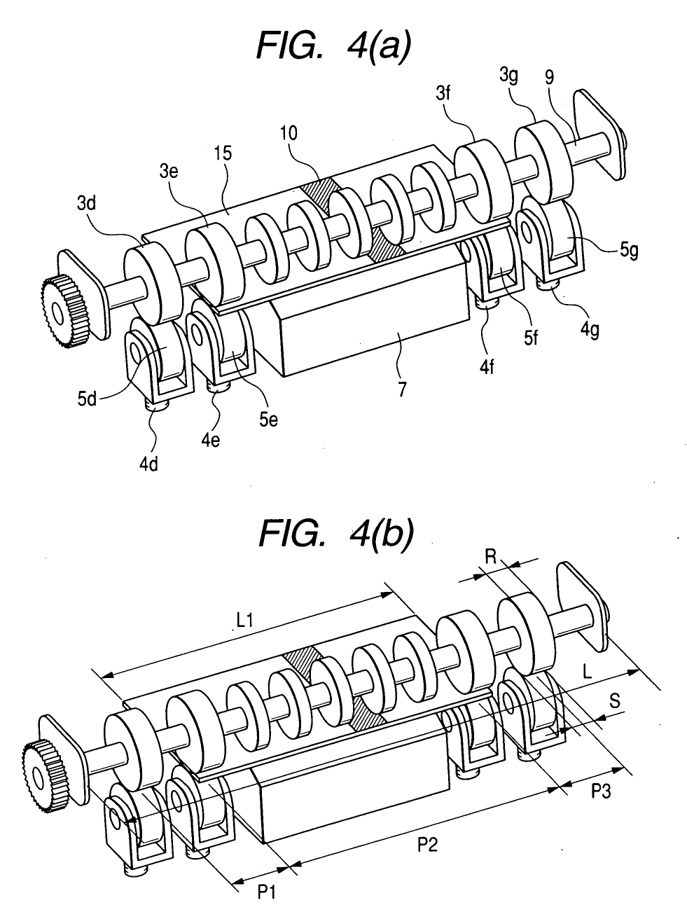

FIG. 3 is a perspective view showing a variation of the arrangement in FIG. 2. As shown in FIG. 3, sensor-opposed rollers 12 (12a, 12b, 12c, 12d) and sheet-reading sensors 7 (7a, 7b, 7c, 7d) are arranged in an alternate form for transport rollers 3 (3d, 3e, 3f, 3g, 3h) and tension rollers 12 (12a, 12b, 12c, 12d), respectively. Such staggered arrangement at required intervals makes it possible to read the magnetic information printed over an entire width of a sheet. However, since the plurality of sensors 7 are provided, the above staggered arrangement increases the number of components and hence, a price of the apparatus, in comparison with the example of FIG. 2. A rubber material of the sensor-opposed rollers, distance D with respect to the sensors 7, and other factors are not described herein, because all these factors are the same as those described above. The same also applies to FIGS. 4A and 4B.

FIG. 4A is a perspective view of the sections shown in FIG. 2. Reference numbers are modified for the sake of convenience in description. In comparison with the variation in FIG. 3, magnetic sensors 7 can be integrally molded and the magnetic information 10, in particular, that is present almost centrally on the sheet 15 transported can be accurately detected and read. Sensor-opposed rollers are arranged at positions opposed to the sensors 7, and four transport rollers 3 in all (i.e., 3d, 3e, 3f, 3g), two at each end in an axial direction, are arranged. As shown in FIG. 4A, tension rollers 5d, 5e, 5f, 5g rotatable with respect to the respective transport rollers 3 are each supported by a retaining spring 4d, 4e, 4f, or 4g, so as to be in contact with the associated transport rollers 3. Paper currencies are therefore transported along the surfaces of the magnetic sensors 7 while being held between the transport rollers 3 and the tension rollers 5.

FIG. 4B shows axial arrangement intervals between the rollers.

Axial transport space L for sheets has a certain spatial margin for a width of the largest sheets handled in an ATM, that is, transported to the discrimination unit. At the same time, consideration is also given to changes in a transport posture of the minimum applicable sheet 15 in transport space L due to shifting, skewing, or the like. That is to say, the sensors 7 and the transport rollers 3 are arranged to ensure that irrespective of where in transport space L the sheet 15 of the minimum size is transported, the section of the sheet 10 that retains magnetic information 10 moves past along detection surfaces 8 of the sheet-reading sensors 7.

To ensure stable transport performance of the transport rollers 3, transport force is given to the sheet in at least one place, desirably, at least two places, on one side of each sensor 7 (two places on one side are shown by way of example in the figure). The transport force is desirably given in at least two places because if the sheet is held and transported in one place, transport performance may be unstable since the resistance applied to the sheet during contact with the transport path or other portions will rotate the sheet at the position where it is being held.

The transport rollers 3d, 3e, 3f, 3g are arranged and installed so that intervals P1, P2, P3 between adjacent transport rollers 3 are set to be equal to or less than width L1 of the sheet 15 of the minimum applicable size. As is obvious from the figure, interval P2 between the transport rollers 3e and 3f in two central places is the largest of the three intervals, and P2, that is, a lateral center-to-center distance between the two transport rollers, is 100.1 mm. The other two transport roller intervals, P1 and P3, are both set to 16.4 mm. Even if the sheet is held in at least one place, stable transport performance can be achieved by using the method described below. Forming the transport roller 3d or 3e and the transport roller 3f or 3g into a shape of one roller and increasing an axial rubber width R of the roller and an axial width S of the tension rollers 5 allows rotations of sheets to be prevented, even if the sheets undergo resistance during contact with the transport path or other portions.

As described above, it is possible to achieve stable sheet-reading performance and to bestow transport force on the sheet-transporting and sensor-opposed rollers 9 opposed to the sheet-reading sensor 7. The transport rollers arranged in proximity to and in front and rear of the sheet-reading sensor 7 can be omitted as a result. In addition, even if plural media are simultaneously transported or media of unusual shapes or quality are transported, the sensor-opposed rollers 12 deform the respective outside diametral sections, thus permitting those media to move through.

In other words, even if plural media are simultaneously transported or media of unusual shapes or quality are transported, provided that low-hardness resilient rollers opposed to a sheet-reading sensor, and resilient transport rollers harder than the low-hardness resilient rollers opposed to the sheet-reading sensor are arranged on a fixed driving roller shaft not actuated vertically, the low-hardness resilient rollers opposed to the sheet-reading sensor can deform the respective outside diametral sections, thus permitting the above media to be moved through. In addition, transport force can be given to sheets by combining the transport rollers coaxially arranged at positions not opposed to the sheet-reading sensor (i.e., resilient rollers harder than the low-hardness resilient rollers opposed to the sheet-reading sensor), and rotatably supported tension rollers.

According to the present embodiment, it is possible to stabilize the transport of sheets and to enhance the sheet-reading accuracy of the sensor. Also, the transport rollers arranged in proximity to and in front and rear of the sheet-reading sensor and the rotatably supported tension rollers can be disused, which, in turn, makes it possible to prevent dimensional extension and multi-construction of the sheet reader.

1. A roller assembly disposed in neighborhood of a reading sensor which detects and reads information of sheets transported, the roller comprising:
a plurality of rollers each arranged coaxially; and
a plurality of resilient rollers different in hardness from each other;
wherein a first resilient roller of the resilient rollers is disposed at a position opposed to the reading sensor, and a second resilient roller, of the resilient rollers, harder than the first resilient roller is disposed at a position not opposed to the reading sensor.

2. The roller assembly according to claim 1, wherein:
the second resilient roller includes a driving roller that gives driving force to the sheets, and a tension roller that rotates with rotation of the driving roller, and transports the sheets by holding the sheets between the driving roller and the tension roller.

3. The roller assembly according to claim 2, wherein:
the driving roller and the tension roller are arranged with their contact position being substantially flush with a sensor surface of the reading sensor.

4. The roller assembly according to claim 1, wherein:
the first resilient roller is disposed with a required spatial interval provided between an outside diametral section of the first resilient roller and the reading sensor.

5. The roller assembly according to claim 4, wherein:
an interval essentially twice an average thickness of the sheets transported is ensured as the required spatial interval.

6. The roller assembly according to claim 1, wherein:
an axial thickness of the first resilient roller is smaller than an axial thickness of the second resilient roller.

7. The roller assembly according to claim 1, wherein:
a diameter of the first resilient roller is smaller than a diameter of the second resilient roller.

8. The roller assembly according to claim 1, wherein:
the first resilient roller has a plurality of resilient rollers along a sensor surface of the reading sensor.

9. The roller assembly according to claim 1, wherein:
the second resilient roller has a plurality of resilient rollers disposed on both sides of the first resilient roller.

10. The roller assembly according to claim 9, wherein:
the number of resilient rollers on one side of the second resilient roller is plural.

11. The roller assembly according to claim 9, wherein:
an axial-arrangement spatial interval between the resilient rollers on one side of the second resilient roller and the resilient rollers on the other side is smaller than a width of the minimum-size sheets transported.

12. The roller assembly according to claim 1, wherein:
the second resilient roller is constituted by first and second rollers disposed on one side of the first resilient roller, and third and fourth rollers disposed on the other side of the first resilient roller; and
an axial spatial interval between the second roller and the third roller is greater than an axial spatial interval between the first roller and the second roller, and an axial spatial interval between the third roller and the fourth roller.

13. A discrimination apparatus that discriminates a denomination, and genuineness/falseness, of the paper currency transported, the apparatus comprising:
a magnetic sensor that detects the magnetic information contained in the paper currency; and
a roller assembly provided on a shaft opposed to the magnetic sensor;
wherein:
said roller assembly includes a sensor-opposed roller opposed to a sensor surface of the magnetic sensor, and transport rollers disposed at a position not opposed to the sensor surface, and on both sides of the sensor-opposed roller, the transport rollers coming into contact with, and transporting, the paper currency; and
a required spatial interval is provided between the sensor-opposed roller and the sensor surface.

14. The discrimination apparatus according to claim 13, further comprising:
a tension roller having a racing capability that works with the transport rollers in order to hold from both sides, and transport, the paper currency.

15. The discrimination apparatus according to claim 13, wherein:
the sensor-opposed roller has hardness lower than hardness of the transport rollers.

16. The discrimination apparatus according to claim 15, wherein:
the sensor-opposed roller is formed from silicon rubber whose rubber hardness ranges from 15 to 30 HS.

17. The discrimination apparatus according to claim 13, wherein:
the sensor-opposed roller has a diameter smaller than a diameter of the transport rollers.

18. The discrimination apparatus according to claim 17, wherein:
the sensor-opposed roller has a roller diameter of 19.1 mm.

19. The discrimination apparatus according to claim 13, wherein:
the sensor-opposed roller has an axial width smaller than an axial diameter of the transport rollers.
